(19) United States
(12) Patent Application Publication
(10) Pub. No.: US 2005/0112355 A1
(43) Pub. Date: May 26, 2005

(54) Method for stiffening or reinforcing a member in a cost effective manner and a member which is made in accordance with the method

(76) Inventor: Joseph Wycech, Warren, MI (US)

Correspondence Address: John G. Chupa, Esq.;Law Offices of John Chupa & Associates, P.C., Ste. 50, 28535 Orchard Lake Rd., Farmington Hills, MI, 48334, US

(21) Appl. No.: 11/021,161

(22) Filed: Dec. 22, 2004

Related U.S. Application Data
(63) Continuation-in-part of application No. 10/099,572, filed on Mar. 15, 2002, now abandoned.

(51) Int. Cl. B32B 5/22; B29C 31/00; B32B 3/26; B29C 67/20

(52) U.S. Cl. 428/304.4; 428/317.9; 264/413

(57) ABSTRACT

A member (10), a support insert (126, 216), a method for forming member (10), and a method for stiffening a member (10) by use of support insert (126, 216). Member (10) includes a foam material (16) which is attached to the member (10) by the use of a layer of polyurea material. These layers cooperate to rigidize the member (10) and reduce the noise generation and transmission attributes of the member (10).

This is a continuation-in-part of pending U.S. patent application Ser. No. 10/099,572, filed Mar. 15, 2002.

### FIELD OF THE INVENTION

The present invention generally relates to a method for stiffening or reinforcing a member in a cost effective manner, to a support member which is selectively coupled to the member, and to a member and a support insert which is made in accordance with the method and more particularly, to a method for cost effectively creating a member, a support member, and a support insert which may be used within an assembly and which increases the overall strength and sturdiness of the member and the assembly while concomitantly improving the noise generation and/or noise transmission attributes of the assembly and improving the noise generation and/or noise transmission attributes of the member.

### BACKGROUND OF THE INVENTION

Assemblies, such as and without limitation an automobile and a dishwasher, are created by the cooperative interconnection of various members (hereinafter the various interconnected members which cooperatively form an assembly are sometimes collectively referred to as “constituent elements” or “constituent elements of the assembly”). Further, it should be understood that the term “member”, as used in this-description, means any tangible item which may be used, either singularly or in cooperative combination with other members or other tangible items, to form an assembly. As such, the term “member” is to be construed in the broadest manner possible and, as is evident from the description below, the principles of the present invention are advantageously applicable to any tangible item.

Further, the overall structural integrity of an assembly is dependent upon the structural integrity of each of these cooperatively interconnected members which form the assembly and the various operational characteristics or attributes of the completed assembly, such as and without limitation, the amount of noise which is emitted by the assembly as it is operated, is also dependent upon the various attributes and characteristics of the constituent elements that form the assembly.

It is generally considered to be a desirable objective to create an assembly which is relatively sturdy or strong and which generates relative low amounts of noise as it is operated. While these characteristics are highly desirable, the achievement of this objective is relatively costly, typically requiring the use of relatively heavy and costly constituent elements. Moreover, not only do these relatively heavy constituent elements increase the overall cost of the produced assembly, they typically and undesirably increase the overall amount of energy which is utilized by the assembly (i.e., increasing the weight of the hood and other constituent elements of an automobile typically increases the overall amount of fuel which is used by the automobile as the automobile is operated).

It is therefore desirable to provide a method for increasing the stiffness or the strength of a member in a cost effective manner and without appreciably increasing the weight of the member, effective to allow the overall created assembly to have desirable operating attributes and characteristics. It is also desirable to provide a cost effective method for reducing the noise generated or transmitted by an assembly and for reducing the amount by which a member vibrates. The present invention achieves these and many other objectives in a new and novel fashion which is further set forth below.

### SUMMARY OF THE INVENTION

It is a first non-limiting advantage of the present invention to provide a method for stiffening or strengthening; and “rigidizing” a member in a manner which overcomes the various previously delineated disadvantages of prior-member strengthening or stiffening methods.

It is a second non-limiting advantage of the present invention to provide a method for reducing the noise produced by an assembly in a manner which overcomes the various previously delineated disadvantages of prior methods.

It is a third non-limiting advantage of the present invention to provide an article or member which is produced by the methodology of the invention.

It is a fourth non-limiting advantage of the present invention to provide a method for stiffening a member. Particularly, the method includes the steps of depositing flexible elastic material on at least a portion of the member; providing a filler material; placing the filler material onto the applied flexible elastic material; and depositing flexible elastic material onto the filler material.

It is a fifth non-limiting advantage of the present invention to provide a method for stiffening a member. Particularly, the method includes the steps of providing foam material; depositing flexible elastic material onto the foam material; and coupling at least one surface of the member to the deposited flexible elastic material.

It is a sixth non-limiting advantage of the present invention to provide an article which is made by the process- of providing a first material; forming the first material into a certain shape; depositing flexible elastic material onto at least one surface of first material; providing foam material; placing the foam material onto the deposited flexible elastic material; and depositing flexible elastic material onto the foam material.

It is a seventh non-limiting advantage of the present invention to provide an article which is made by the process of providing a first material; forming the first material into a certain shape; providing foam material; applying a flexible elastic material onto the foam material; and coupling the applied flexible elastic material to the first material.

It is an eighth non-limiting advantage of the present invention to provide a member comprising a first outer portion which has a certain predetermined shape and which has an inner surface; a first layer of a polyurea composition which substantially covers the entire inner surface; a layer of foam material having a first outer surface and a second inner surface which substantially covers and is coupled to the first layer of the polyurea composition; and a second layer of the polyurea composition which resides upon substantially the entire first outer surface of the foam material.

It is a ninth non-limiting advantage of the present invention to provide a method for stiffening a member. Particularly, the method comprises the steps of: providing a member to be stiffened; providing at least one support insert having at least one pocket; providing a first amount and a second amount of flexible elastic material; depositing the first amount of flexible elastic material on at least a portion of the member; disposing the at least one support insert upon the member and above the first amount of flexible elastic material; providing an amount of certain material; placing the amount of certain material within the at least one pocket; and depositing the second amount of flexible elastic material onto the glass filled polymer and the at least one support insert, thereby stiffening the member.

These and other features and advantages of the present invention will become apparent from a reading of the following detailed description of the preferred embodiment of the invention and by reference to the following drawings.

### BRIEF DESCRIPTION OF THE DRAWINGS

FIG. 1 is a perspective partial view of an assembly including a member which is made in accordance with the teachings of the preferred embodiment of the invention;

FIG. 2 is a perspective view of the member which is shown in FIG. 1;

FIG. 3 is a perspective view of a member which is made in accordance with the teachings of an alternate embodiment of the invention;

FIG. 4 is a partial side sectional view of the member which is shown in FIG. 2;

FIG. 5 is a partial side sectional view a member which is made in accordance with the teachings of yet another alternate embodiment of the invention;

FIG. 6 are diagrammatical views of a method for stiffening a member according to the teachings of a first embodiment of the invention;

FIG. 7 are diagrammatical views of a method for stiffening a member according to the teachings of -a second embodiment of the invention;

FIG. 8 is a perspective partial cutaway view of a vehicular hood which is made in accordance with the teachings of the invention;

FIG. 9 is a view of the underside of the vehicular hood which is shown in FIG. 8;

FIG. 10 is a partial side sectional view of the vehicular hood which is shown in FIGS. 8 and 9;

FIG. 11 is a view of the underside of a member which is made in accordance with the teachings of an alternate embodiment of the invention;

FIG. 12 is a cross sectional view of a portion of the member which is shown in FIG. 11;

FIG. 13 is a view of the underside of the vehicular hood which is made in accordance with the teachings of an alternate embodiment of the invention; and

FIG. 14 is a cross sectional view of a portion of the vehicular hood which is shown in FIG. 13.

### DETAILED DESCRIPTION OF THE PREFERRED EMBODIMENT OF THE INVENTION

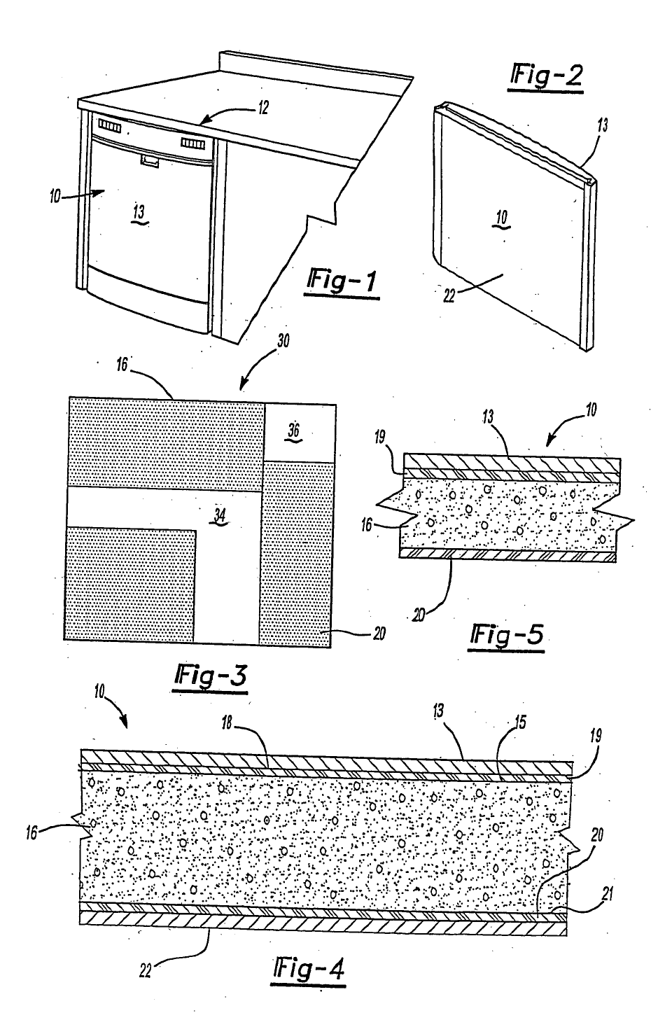

Referring now to FIGS. 1, 2, and 4 there is shown a dishwasher facia or front member 10 which is made in accordance with the teachings of the preferred embodiment of the invention and which is shown in an operative assembled relation with a dishwasher 12. Particularly, front facia member 10 is adapted to be used with any type of dishwasher and nothing in this description is meant to limit the use of frontal member 10 to a particular type of dishwasher, such as that which is shown in the various FIGS. 1, 2, and 4. Further, as is evident from the following discussion, it should be apparent to those of ordinary skill in the art that the principles of the various inventions which are included in this Application are not limited to use with a dishwasher or a dishwasher facia member. Rather, these principles are applicable to substantially any tangible item or member and nothing in this Application is meant to limit the general applicability of the various described inventions to a wide range of tangible items. Hence, dishwasher 12 and facia member 10 are used for the sole purpose of illustrating the general principles of some of the inventive concepts of the inventions and are not limiting.

Particularly, dishwasher frontal member 10 may be formed in any desired shape and size and, in one non-limiting embodiment, generally comprises a generally rectangular shape and is generally formed from conventional steel, aluminum, or other commercially available material and has an exterior surface 13 and an interior surface 18. Particularly, it is generally desirable to manufacture the dishwasher frontal member 10 by the use of a relatively thin material (e.g., the frontal facia member is a “thin walled member”) in order to reduce the cost of producing the member. 10 and the dishwasher 12; reduce the overall weight of the dishwasher 12, thereby reducing shipping costs, effective to allow the dishwasher to be easily transported; and reduce the overall energy consumption of the dishwasher 12. However, while the use of a relatively thin walled member 10 does provide the previously delineated benefits, it is easily deformable or susceptible to damage, especially as the member 10 is installed onto the dishwasher 12, and is easily vibrated and easily transmits the noise which is generated by the dishwasher assembly 12 to the surrounding area or the ambient environment in which the dishwasher 12 is disposed. Hence, the use of a thin walled facia member 10 undesirably increases the noise associated with the dishwasher 12 and undesirably transmits the generated noise to those in close proximity to the dishwasher 12. The present invention may be used to reduce or eliminate the undesired attributes or characteristics of such a thin walled facia member in a manner which does not appreciably increase the production costs of the dishwasher 12 and which, by way of example and without limitations, “rigidizes” and strengthens the member 10.

Particularly, the dishwasher facia member 12 includes a foam filler or foam “block” portion 16 which has a first surface 15 which is coupled to the inner surface 18 of the frontal member 10 by the use of a first layer 19 of a highly elastic elongated material such as but not limited to a polyurea or a polyurea composition. Foam filler portion 16 further has a second surface 21 which is substantially covered with a second layer 20 of the highly elastic elongated material which, as earlier stated, comprises, by way of example and without limitation a polyurea or a polyurea composition material. Particularly, in one non-limiting embodiment of the invention, the foam filler portion 16 is substantially the same size and shape as the inner surface 18 (and substantially the same size and the same shape as the member 10) and has a thickness which is substantially larger than the thickness of the facia member 12 (e.g., larger by a factor of about three to about six). As is further best shown in FIG. 4, the dishwasher facia member 10 further includes an inner panel 22 which is coupled to the foam filler material 16 by the use of the second layer 20 of polyurea material.

In one non-limiting embodiment of the invention, the foam filler portion 16 comprises commercially available styrofoam material and the polyurea material comprises commercially available material which is referred to as “Quantumshield” which is available from The Aristo-Cote Company which is located at 111 Shafer Drive, Romeo, Mich. 48065, although other materials and compositions may be utilized. Hence, the foam filler portion 16 and the employed polyurea composition are relatively cost effective and are readily commercially available.

Moreover, Applicant has achieved unexpected results by combining the previously delineated layers of polyurea material 19, 20 and the foam material 16 in the foregoing manner. That is, the measured resistance to deformation of the dishwasher facia member 10 increases about five hundred percent relative to a conventional dishwasher facia member and the susceptibility to vibration decreases about five hundred percent relative to a conventional dishwasher facia member by combining the utilized polyurea composition with the foam material 16 in the foregoing manner. Hence, the combination of the polyurea material layers 19, 20 and the foam filler material 16 provides these unexpected benefits in a new and novel fashion. In one non-limiting embodiment of the invention, the entire surface 15 and the entire surface 21 receive the polyurea material, although other amounts may be used. In another non-limiting embodiment of the invention, layer 20 is not applied to surface 21 and inner panel 22 is coupled directly to or integrally, formed with the foam material 16.

In yet another non-limiting embodiment of the invention, as is best shown in FIG. 5, the dishwasher facia member 10 does not include an inner panel 22 and this alternate embodiment still provides substantially the same foregoing benefits over a conventional dishwasher facia member. In this alternative embodiment, the layer of polyurea material 20 may be placed upon surface 21 or material 20 may be omitted (i.e., the foam filler material 16 is left “bare”).

As is best shown in FIG. 3, a dishwasher facia panel 30 may be made in accordance with the teachings of yet another alternate embodiment of the invention. Particularly, in this alternate embodiment of the invention, a passage or indentation, such as and without limitation, passage 34 may be formed within the foam 16 in order to provide support for electrical conduits and/or other electrical devices or busses which communicate power to the dishwasher 12, and another indentation or pocket 36 may be formed within the foam member 16, effective to provide a soap dispenser support or cavity. In this manner, these “preformed” passages, channels, and pockets may further reduce the cost of producing the dishwasher 12 or other assembly and allow for efficient production. Hooks or other members may also be placed within the foam 16. Polyurea material may be placed upon these portions 34, 36, and/or upon the foam 16. Alternatively, no polyurea material may be used upon the foam 16 except the material needed to coupled the foam 16 to the surface 18 of the member 10.

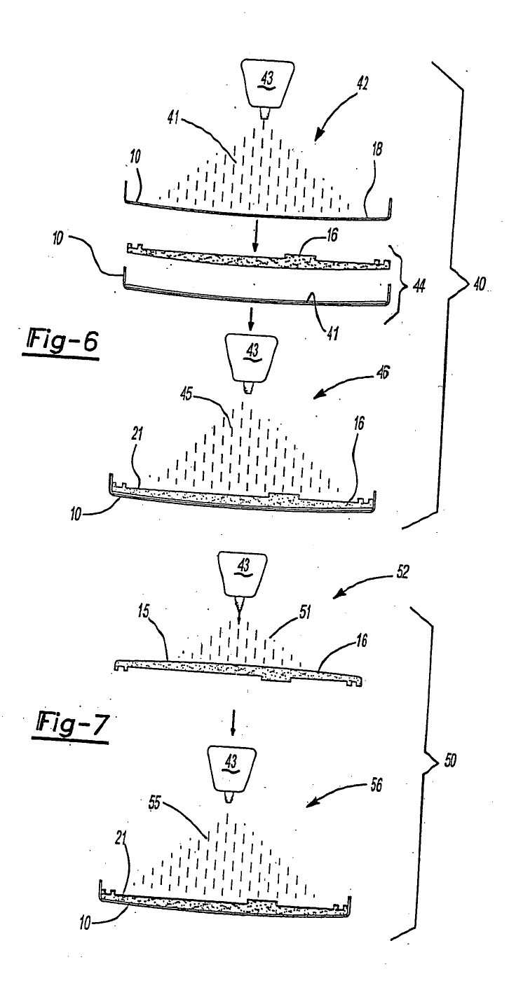

One method 40 to create the dishwasher facia member 12 is shown in FIG. 6. Particularly, the method 40 begins with an initial step 42 in which the polyurea composition material 41 is applied to (e.g., sprayed upon) the inner surface 18 of the member 10 by sprayer 43. In step 44, which follows step 42 the applied material 41 on surface 18 begins to harden or becomes “tacky” and the foam material 16 is then placed upon the previously applied polyurea material 41 thereby causing the foam material 16 to adhere to the inner surface 18 of the member 10. Step 46 follows step 44 and, in this step 46, additional polyurea material 45 is sprayed onto the outer surface 21 of the foam material 16. An inner panel (such as panel 22) may be applied to this deposited polyurea material 45 after it has become tacky. In one non-limiting embodiment of the invention, the thickness of the polyurea material 41 which is applied to the inner surface 18 is substantially similar to the thickness of the polyurea material 45 which is applied to the surface 21, although other thickness arrangements may be utilized.

A second method 50 to create the dishwasher facia member 10 is shown in FIG. 7 and begins with an initial step 52 in which the surface 15 of the foam material or member 16 receives and is substantially covered by a layer of polyurea material 51. Step 56 follows step 52 and, in this step 56, the polyurea material 51 covered surface 15 is then coupled to the inner surface 18 of the member 10, thereby causing the foam member 16 to adhere to the member 10. Additional polyurea material 55 may be applied to the surface 21 and an inner panel 22 may also be utilized and selectively coupled to the surface 21.

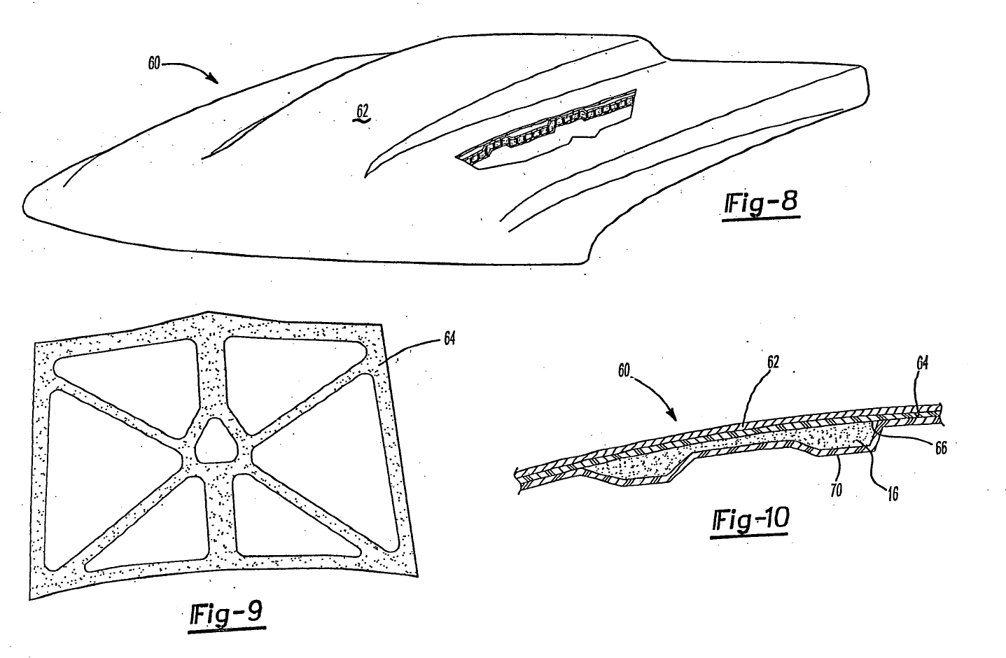

It should be appreciated that many diverse types of members may be strengthened and concomitantly have their noise and vibration transmission and generation characteristics greatly enhanced by the previously delineated methodology of the preferred embodiment of the invention. By way of further example and without limitation, a vehicular hood may be produced in accordance with the teachings of the invention. That is, as shown in FIG. 8-10, vehicular hood 60 may be of substantially any desired shape and size and includes an outer normally visible surface 62 and an inner surface 64 upon which a layer of polyurea material 66 resides. Particularly, the layer of polyurea material 66 couples the inner surface 64 to a foam material 16 which is substantially the same size and the same shape as the vehicular hood 60. A second layer 70 of polyurea material may cooperate with the first layer 66 of polyurea material to encapsulate foam material 16 (i e., layer 70 is attached to the exposed surface of the material 16 which is distant from the surface 64 of the hood 60).

Particularly, the strength of a vehicular hood is enhanced by about five hundred percent by adhering the foam material 16 to the hood 60 in the previously delineated manner. The vibrational generation attribute of the vehicular hood 60 decreases by about three hundred percent by adhering the foam material 16 to the hood in the previously delineated manner. As shown in FIG. 9, it should also be appropriated that the foam material 16 may be of any desired size and shape which strengthens hood 60 while reducing the vibration generation characteristics of hood 60.

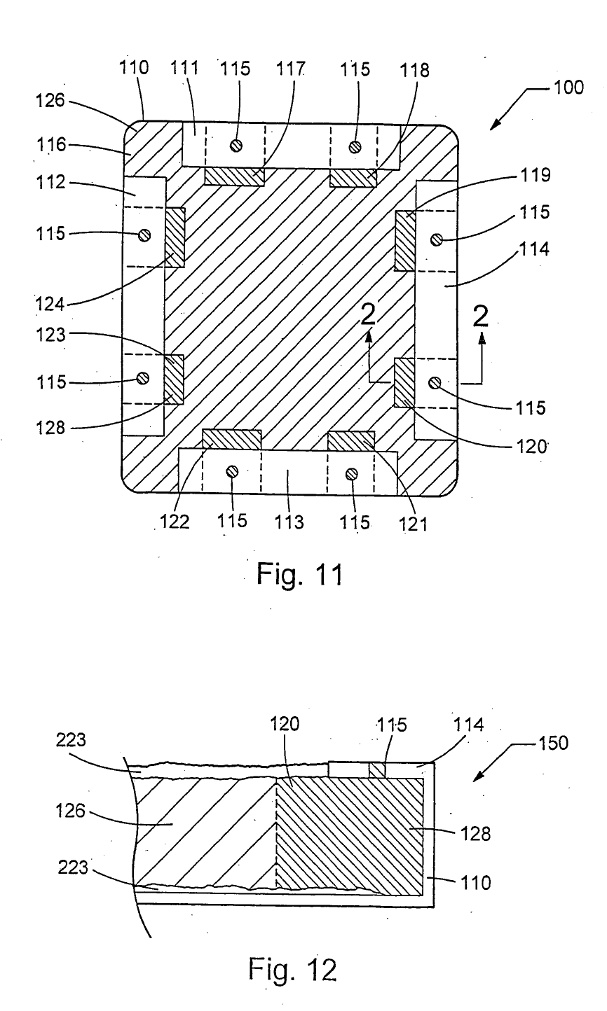

Referring now to FIG. 11, there is shown an inside view of a dishwasher frontal member 100 which is made in accordance with the teachings of an alternate embodiment of the invention. As shown, frontal member 100 comprises a generally square or rectangular shape and is generally formed from conventional steel, aluminum, or other commercially available material and has an exterior surface 110 and an interior surface 116. Further, as best shown in FIG. 12, exterior surface 110 forms a substantially “U” shaped portion 150 having a respective and integrally formed flange 111-114 for each respective side of the substantially square or rectangular shaped frontal member 100. Each respective flange 111-114 includes at least one aperture 115 through which a conventional fastener (not shown) is disposed, effective to couple the frontal member to another assembly (not shown), such as an without limitation a dishwasher. It should be understood that nothing in this description is meant to limit the flanges 111-114 to contain any particular amount of apertures 115. Rather, the number of apertures 115 which are shown in FIG. 11 (i.e., two apertures per flange) are for illustrative purposes only.

Particularly, interior surface 116 includes a generally rectangular or square support insert 126. At the outset, it should be appreciated to one who is skilled in the relevant art that support insert 126 is not limited to the general shape of a square or a rectangle. Rather, the support insert 126 may be geometrically shaped to substantially any desired shape and the generally square or rectangular shape of support insert 126 which is depicted in FIG. 11 is merely for illustrative purposes only.

Support insert 126 is generally formed from Styrofoam, industrial foam, or other commercially available and lightweight material and has eight substantially identical apertures or generally hollow pockets 117-124 which are each respectively- formed in a location which, when the support insert 126 is inserted upon interior surface 116 and under each respective flange 111-114, are directly below each respective aperture 115 of each respective flange 111-114. It should be appreciated that apertures 115 may be created by a conventional drilling process, laser cutting process, machining process, or substantially any other desired process. It should be further appreciated that the support insert 126 is not limited to the location and number of the pockets 117-124 which are depicted in FIG. 11. Rather, as should be apparent to one who is skilled in the relevant art, support insert 126 may employ substantially any desired number of pockets and, as stated above, each respective pocket 117-124 corresponds -to each respective aperture 115 (i.e., each pocket 117-124 is paired with an aperture 115). It should be further appreciated that each respective pocket 117-124 along with each respective aperture 115 may be formed in substantially any desired location through support insert 126 and flanges 111-114 respectively. It should be understood that nothing in this description is meant to limit the shape and size of the respective pockets 117-124 to any particular shape or size. Rather the size and shape of the respective pockets which are depicted within FIGS. 11 and 12 are for illustrative purposes only. Hence, as should be obvious to one who is skilled in the relevant art, each respective pocket 117-124 may be substantially any desired shape and size and, each respective pocket 117-124 may be shaped and sized substantially identical to the remaining respective pockets 117-124 or each respective pocket may be shaped completely different and sized completely different as compared to the remaining respective pockets 117-124.

In operation, interior surface 116 is sprayed with a highly elastic and elongated material 223 (e.g., polyurea or polyurea composition material) and support insert 126 is inserted upon the highly elastic elongated material 223 and under each respective flange 111-114, in a position in which each respective pocket 117-124 aligns beneath each respective aperture 115 of each flange 111-114. Once the support insert 126 has been inserted and aligned, a glass filled polymer 128 is injected or otherwise disposed within each respective pocket 117-124, such that each respective pocket is substantially filled or “topped-off” with the glass filled polymer 128. In one non-limiting embodiment, the glass filled polymer 128 is disposed within each respective pocket 117-124, such that each respective aperture 115 of flanges 111-114 are substantially filled or “topped-off” with the polymer 128.

In the preferred embodiment, once the polymer 128 has substantially “dried” or set, a second application of the highly elastic elongated material 223 is applied over substantially the entire surface of the exposed support insert 126, thereby sealing the support insert within the frontal member 100 while concomitantly providing an aesthetically appealing and uniform surface. It should be understood that, in this manner, the frontal member 100 may be fastened to the dishwasher assembly (not shown) with a conventional screw or fastening device (not shown) while concomitantly utilizing the same conventional screw or fastening device to further contain the support insert 126 within the frontal member 100. That is, after the glass filled polymer has set or dried, a conventional fastener, such as a screw may be operatively placed through the dishwasher assembly in a conventional manner, through each respective aperture 115, and driven into the glass filled polymer, effective to contain the support insert 126 between the frontal member 100 and the dishwasher (not shown). It should be appreciated that the natural bonding characteristics of the highly elastic elongated material 223 and the glass filled polymer 128 provides the frontal member 100 with a significantly increased level of stability, rigidity, and strength.

In one non-limiting embodiment, the second application of the highly elastic elongated material 223 is applied over substantially the entire surface of the exposed support insert 126 before the respective pockets 117-124 are injected or otherwise filled with the glass filled polymer 128.

Referring now to FIG. 12, there is shown a cut away section of the “completed” frontal member 100 which is taken along view line 2-2 of FIG. 11. As shown more clearly in FIG. 12, the first layer of highly elastic elongated material 223, such as and without limitation to polyurea, is applied over substantially the entire interior surface 116 and then the support insert 126 is inserted above the first layer of material 223. After the support insert 126 has been inserted in the manner described above in reference to FIG. 11, each respective pocket 117-124 is injected or otherwise filled with the glass filled polymer 128. Lastly, a second layer of highly elastic elongated material 223, such as and without limitation to polyurea, is applied directly above the entire surface of the support insert 126 and each respective pocket 117-124 containing the glass filled polymer 128. In this manner, the conventional support structure of the frontal member 100 (i.e., conventional support structures of frontal members, such as member 100, are traditionally formed out of a metal material) may be obviated, thereby significantly increasing rigidity and dampening characteristics of the frontal member 100 while concomitantly reducing the cost of manufacturing (i.e., by obviating the metal support frame)and weight of the frontal member 100 (i.e., by obviating the metal support frame).

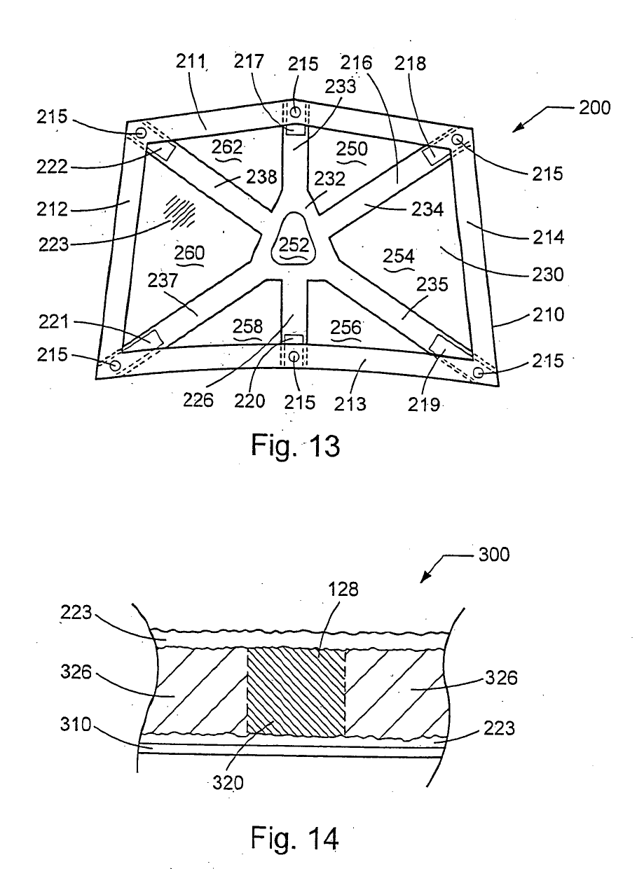

Referring now to FIG. 13, there is shown a vehicular hood 200 which is made in accordance with the teachings of yet another alternate embodiment. As shown, vehicular hood 200 may be of substantially any desired shape and size and includes an outer normally visible surface 210 and an inner surface 230 upon which a layer of polyurea material 223 resides. Particularly, the outer surface 210 forms a substantially “U” shaped portion (not shown) which is substantially similar to the “U” shaped portion 150 of frontal portion 100. That is, the “U” shaped portion (not shown) of vehicular hood 200 has a respective and integrally formed flange 211-214 for each respective side of the substantially square or rectangular shaped vehicular hood 200. Each respective flange 211-214 includes at least one aperture 215 through which a conventional fastener (not shown) may be disposed. It should be understood that nothing in this description is meant to limit the flanges 211-214 to contain any particular amount of apertures 215. Rather, the number of apertures 215 which are shown in FIG. 13 are for illustrative purposes only.

Vehicular hood 200 further includes a support insert 216. Support insert 216 is generally formed from Styrofoam, industrial foam, or other commercially available and lightweight material. As shown, support insert 216 has a generally circular shaped and hollow middle portion 232, out of which six substantially similar support arms 233-238 extend and terminate underneath a respective flange 211-214 or a corner created by two respective flanges 211-214. Moreover, each respective support arm 233-238 includes a respective one of six substantially identical apertures or generally hollow pockets 217-222 which are each respectively formed in a location which, when the support insert 216 is inserted upon interior surface 230 and under each respective flange 211-214, are directly below each respective aperture 215 of each respective flange 211-214.

As stated above, it should be understood that nothing in this description is meant to limit the shape and size of the respective pockets 217-222 to any particular shape or size. Rather the size and shape of the respective pockets which are depicted within FIG. 13 are for illustrative purposes only. Hence, as should be obvious to one who is skilled in the relevant art, each respective pocket 217-222 may be substantially any desired shape and size and, each respective pocket 217-222 may be shaped and sized substantially identical to the remaining respective pockets 217-222 or each respective pocket may be shaped completely different and sized completely different as compared to the remaining respective pockets 217-222.

Inner surface 230 may include a plurality of generally hollow areas 250-262 which are created or formed by the support arms 233-238 of support insert 216 either alone (e.g., hollow area 252) or in cooperation with a respective flange 211-214 (e.g. hollow areas 250, 254, 256, 258, 260, and 262). In one non-limiting embodiment, a foam support insert (not shown) which is shaped to conformingly fit the respective shape of each respective hollow area 250-262 may be disposed within the generally hollow areas 250-262., thereby further increasing the rigidity and dampening of the vehicular hood 200. In yet another non-limiting embodiment, the support insert 216 may cover substantially” the entire interior surface 230 of the vehicular hood 200, in the same manner as support insert 126 covers the entire interior surface 116 of frontal member 100 of FIG. 11.

It should be understood that support insert 216 may be of substantially any shape, geometric configuration, design, or size and, nothing in this description is meant to limit the shapes geometric configuration, design, or size to any particular shape, geometric configuration, design, or size. Rather, the size, shape, geometric configuration, and design which is depicted in FIG. 13 is merely for illustrative purposes only. Hence, many alternative shapes, designs, geometric configurations, and sizes are equally as applicable to support insert 216 as the shape, geometric configuration, design, and size which is shown in FIG. 13.

In operation and after the support insert 216 is coupled to the interior surface 230 of hood 200, a layer of highly elastic elongated material 223, such as and without limitation to polyurea, is applied to and couples the inner surface 230 to support insert 216 of vehicular hood 200. In one non-limiting embodiment, a second layer of highly elastic elongated material 223 may cooperate with the first layer 223 of polyurea material to encase the support insert 216 (i.e., the second layer is attached to the exposed surface of the insert 216 which is distant from the surface 230 of the hood 200). In the preferred embodiment, each respective pocket 217-222 of support insert 216 is injected or otherwise filled with a glass filled polymer, such as polymer 128 of FIG. 12, such that each respective pocket 217-222 is substantially “topped-off” (i.e., the level of polymer 128 is substantially flush with the top side of the support insert 216). In one non-limiting embodiment, polymer 128 is injected into each respective pocket 217-222 such that each respective aperture 215 is substantially filled.

After the glass filled polymer 128 has set or dried, a second layer of the highly elastic elongated material 223 is sprayed or otherwise applied to substantially the entire surface area of the vehicular hood 200, thereby encasing the entire support structure within a “shell” or coat of highly elastic elongated material 223. As stated above, it should be appreciated that the natural bonding characteristics of the highly elastic elongated material 223 and the glass filled polymer 128 provides the vehicular hood 200 with a significantly increased level of stability, rigidity, and strength.

In one non-limiting embodiment, a conventional fastening device, such as a screw, may be disposed or driven through each respective aperture 215 and into each respective pocket 217-222 containing the set glass filled polymer 128. In this manner, the support insert 216 may further be secured to the interior surface 230 of the vehicular hood 200. In yet another alternate embodiment, a layer of highly elastic elongated material 223 may be applied directly above each respective and driven conventional fastener, thereby completely sealing the entire support insert 216 and protecting the entire support insert 216 from environmental damage (e.g., moisture, oxidization, and the like).

Referring now to FIG. 14, there is shown a cross section 300 of a support insert 326 which is made in accordance with the teachings of an alternate embodiment of the invention. As shown, support insert 326 may be constructed or utilized within substantially any desired surface, such as surface 310, that does not have a flange. That is, support insert 326 may be selectively coupled to substantially any desired surface by the use of a formed pocket 320. Pocket 320, in this alternate embodiment, may be formed in substantially any desired location upon/within support insert 326. It should be understood that support member 326 is substantially similar to support inserts 126, 216 and the teachings of this alternate embodiment are equally applicable to a fascia or frontal member, such as frontal member 100 or a vehicular hood, such as vehicular hood 200. It should be further understood that the teachings of this alternate embodiment are equally applicable to any surface which may require support, strengthening, dampening, or the like. Hence, nothing in this description is meant to limit support insert 326 to any particular surface to which support insert 326 is inserted. Rather, support insert 326 may be utilized upon a surface which contains flanges or a surface which does not contain flanges.

As shown, a layer of highly elastic elongated material 223 is sprayed or otherwise applied to the surface 310 and support insert 326 is inserted upon the layer of highly elastic elongated material 223. Further as shown, a pocket 320 has been formed upon/within the support insert 326. It should be appreciated that the pocket 320 may be formed in substantially any desired and conventional manner. As described above in reference to pockets 117-124 and 217-222, pocket 320 is injected or otherwise filled with a glass filled polymer 128. Once the glass filled polymer 128 has set, a second layer of highly elastic elongated material 223 is sprayed or otherwise applied to the entire surface of the support insert 326, thereby encasing support insert 326 within a shell of highly elastic elongated material 223. In this manner, the support insert is substantially protected from environmental damage (e.g., moisture, oxidization, and the like).

In one non-limiting embodiment, a blind aperture (not shown) is created within the set glass filled polymer 128 of pocket 320, effective to allow a conventional fastener, such as a screw, to be driven into the pocket 320. In yet another non-limiting embodiment, once the blind aperture (not shown) is created within the filled pocket 320, a layer of highly elastic elongated material 223 is sprayed or otherwise deposited upon the entire surface of the support insert 326, thereby encasing support insert 326 within a shell of highly elastic elongated material 223. In this manner, the support insert is substantially protected from environmental damage (e.g., moisture, oxidization, and the like).

It is to be understood that the invention is not limited to the exact construction and methodology which has been delineated above, but is meant to encompass all equivalents of such a construction and methodology to the fullest and broadest extent allowable under the law. For example and without limitation, filler material 16 disclosed in this Application may be composed of substantially any suitable commercial material, such as polyvinyl chloride, corrugated paper, polyethylene, or EVA. In further example and without limitation, the glass filled polymer 128 may be replaced with a plurality of different materials, such as a thermosetting material (e.g., epoxy, polyurethane, polyester, and the like) or a non-thermosetting material.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. A method for stiffening a member comprising the steps of:
providing a member to be stiffened;
providing at least one support insert having at least one pocket;
providing a first amount and a second amount of flexible elastic material;
depositing said first amount of flexible elastic material on at least a portion of said member;
disposing said at least one support insert upon said member and above said first amount of flexible elastic material;
providing an amount of certain material;
placing said amount of certain material within said at least one pocket; and
depositing said second amount of flexible elastic material onto said glass filled polymer and said at least one support insert, thereby stiffening said member.

35. (canceled)

36. The method of claim 34 wherein said amount of certain material comprises a non-thermosetting material.

37. (canceled)

38. The method of claim 35 wherein said thermosetting material comprises polyester

39. (canceled)

40. (canceled)

41. The method of claim 34 wherein said first and said second amount of flexible elastic material comprises a polyurea composition.

42. The method of claim 41 wherein said step of depositing a first amount of flexible elastic material onto at least a portion of said member comprises the step of spraying said first amount of flexible elastic material onto said member.

43. The method of claim 42 wherein said step of depositing said first amount of flexible elastic material onto at least a portion of said member comprises the step of spraying an entire surface of said member with said flexible elastic material.

44. (canceled)

45. The method of claim 43 wherein said support insert covers only a portion of said member.

46. (canceled)

47. The method of claim 45 wherein said member comprises a vehicular hood, said method further comprising said steps of:
providing at least one fastener;
disposing said at least one fastener through said at least one pocket; and
driving said at least one fastener into said vehicular hood.

48. (canceled)

49. The method of claim 34 wherein said amount of material is dependant upon a desired rigidity.
